(19) United States
(12) Patent Application Publication
(10) Pub. No.: US 2006/0159417 A1
(43) Pub. Date: Jul. 20, 2006

(54) Information playback apparatus and information playback method

(75) Inventor: Akira Kawamura, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/335,709

(22) Filed: Jan. 20, 2006

(30) Foreign Application Priority Data
Jan. 20, 2005 (JP) 2005-012908

(51) Int. Cl. H04N 5/91

(52) U.S. Cl. 386/68

(57) ABSTRACT

An information playback apparatus comprises a unit which obtains a number of data units to be played back by jumping in accordance with the playback speed, a determination unit which determines whether or not an address in the table corresponding to the obtained number is valid, and a playback unit which plays back, when it is determined that the address is valid, the information based on the valid address, and when it is determined that the address is invalid, the information based on a valid address among addresses of data units to be played back at a time point closer to the current time point than a playback time point of a data unit of the invalid address.

### CROSS-REFERENCE TO RELATED APPLICATIONS

This application is based upon and claims the benefit of priority from prior Japanese Patent Application No. 2005-012908, filed Jan. 20, 2005, the entire contents of which are incorporated herein by reference.

### BACKGROUND

1. Field

The present invention relates to an information playback apparatus and an information playback method for playing back digital information from an optical disk such as, for example, a digital versatile disc (DVD).

2. Description of the Related Art

Conventionally, an optical disc playback apparatus such as a DVD playback apparatus has special playback functions including a fast playback and the like (for example, refer to Jpn. Pat. Appln. KOKAI Publication No. 2002-352515, paragraphs 0130 to 0152, and FIGS. 12 and 13). In this apparatus, data (data unit) is recorded in unit called video object unit (VOBU). At normal playback, data is played back in the sequence of recorded VOBUs while at high speed playback, data is played back by jumping every several VOBUs, and VOBUs that are away from one another in time sequence are played back sequentially. In DVD specifications, an address of a VOBU to be acquired after a VOBU currently being played back is recorded as video object unit search information (VOBU_SRI) in data search information DSI in a navigation pack NV_PCK recorded in the head of VOBU. In the VOBU_SRI, a plurality of start addresses of VOBUs that are played back for 0.5×n seconds before and after a playback start time of the video object unit VOBU including the DSI in the cell are recorded. The specifications describe of how many VOBUs away from the current address, start addresses should be written in each address of the VOBU_SRI.

For fast playback at a high speed, it is necessary to increase the number of VOBUs that are jumped, and to record start addresses of VOBUs that are largely away from the current VOBU in time sequence. For this reason, a VOBU (VOBU_SRI thereof) cannot be recorded until recording of many VOBUs thereafter is completed (until the start address is determined). Namely, a data buffer for the time period for recording many VOBUs is necessary.

However, depending on capacities of data buffers of storage devices, it is not possible to record the start addresses of VOBUs determined by the specifications in all the addresses of the VOBU_SRI. In the case when the start addresses of VOBUs are not recorded, data of each address of VOBU_SRI remains to be a predetermined initial value (this value is invalid as an address). Meanwhile, the speed magnification of high speed playback corresponds to information on how many VOBUs before and after are to be played back, and the playback time for one VOBU. Therefore, it is not determined primarily of how many VOBUs before and after, start addresses should be recorded in order to cope with high speed playback of a desired magnification speed. For this reason, there may be some cases where an address of data to be played back next is not recorded in VOBU_SRI (namely, invalid data as the initial value is recorded therein).

### BRIEF SUMMARY OF THE INVENTION

The present invention is directed to method and apparatus that substantially obviates one or more of the problems due to limitations and disadvantages of the related art.

According to an embodiment of the present invention, an information playback apparatus in which information is recorded for each data unit, a playback speed of the information is variable, and a table storing addresses of data units to be played back in a time range including current time is prepared for each data unit, the information playback apparatus comprises:

a unit configured to obtain a number of data units to be played back by jumping in accordance with the playback speed;

a determination unit configured to determine whether an address in the table corresponding to the obtained number is valid or invalid; and

a playback unit configured to, when it is determined that the address is valid, play back information based on the valid address, and when it is determined that the address is invalid, play back information based on a valid address among addresses of data units to be played back at a time point closer to the current time point than a playback time point of a data unit of the invalid address.

According to another embodiment of the present invention, an information playback method in which information is recorded for each data unit, a playback speed of the information is variable, and a table storing addresses of data units to be played back in a time range including current time is prepared for each data unit, the information playback method comprises:

obtaining a number of data units to be played back by jumping in accordance with the playback speed;

determining whether an address in the table corresponding to the obtained number is valid or invalid; and

playing back, when it is determined that the address is valid, information based on the valid address, and when it is determined that the address is invalid, information based on a valid address among addresses of data units to be played back at a time point closer to the current time point than a playback time point of a data unit of the invalid address.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a configuration of an embodiment of an optical disc playback apparatus according to the present invention;

FIG. 2 is a view for explaining a hierarchy structure of data recorded in an optical disc according to the embodiment;

FIG. 3 is a view for explaining a hierarchy structure of a navigation pack recorded in the optical disc according to the embodiment;

FIG. 4 is a view for explaining a part of the navigation pack recorded in the optical disc according to the embodiment;

FIG. 5 is a flow chart for explaining a high speed playback operation in the case of reading recorded information from the optical disc according to the embodiment; and

FIG. 6 is a flow chart for explaining a high speed playback operation in the case to read recorded information from an optical disc according to a second embodiment of the invention.

### DETAILED DESCRIPTION

An embodiment of an information playback apparatus and an information playback method according to the present invention will now be described with reference to the accompanying drawings.

### FIRST EMBODIMENT

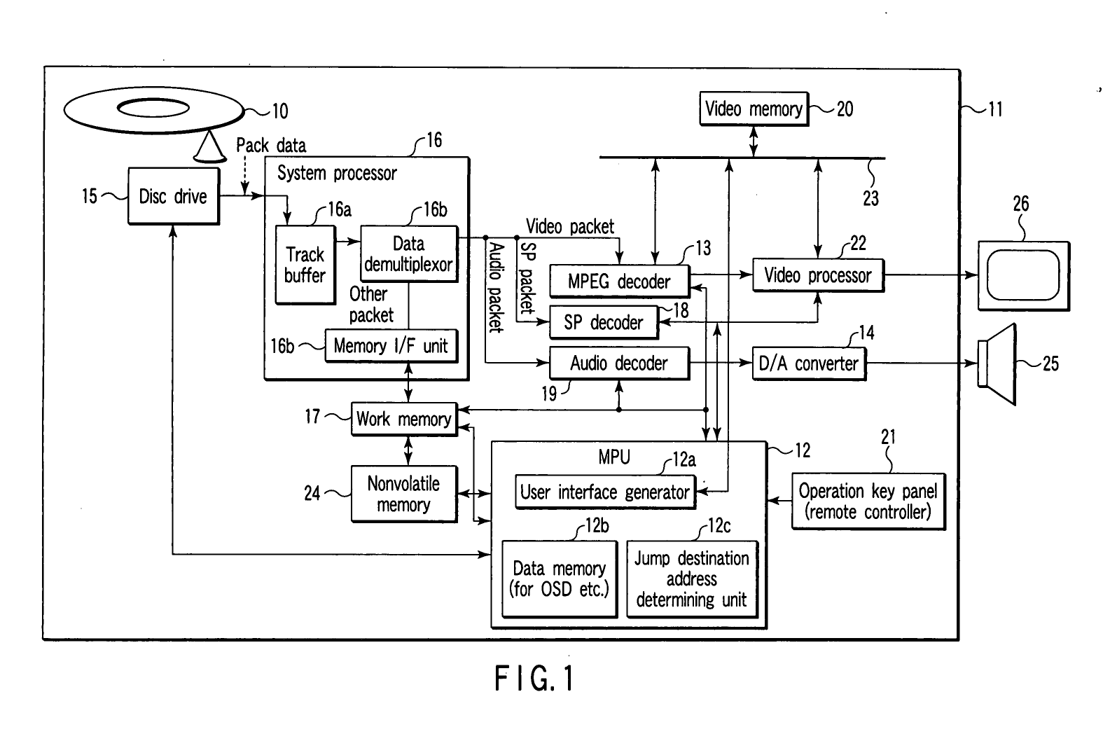

FIG. 1 shows an optical disc (DVD) playback apparatus 11 according to a first embodiment of the present invention. The optical disc playback apparatus 11 includes an MPU 12, an MPEG decoder (video decoder unit) 13, an audio data D/A converter 14, a disc drive 15 for reading information from an optical disc 10, a system processor 16, a work memory 17, an sub picture (SP) decoder unit 18, an audio decoder 19, a video memory 20, an operation key panel as an input device operated by a user (including a remote controller, etc.) 21, a video processor 22, an internal bus 23, and a nonvolatile memory 24 for storing user set information and the like.

To the external side of the optical disc playback apparatus 11, an external speaker 25 is connected via an audio amplifier (or AV amplifier) which is not shown in FIG. 1, and a TV monitor (or video projector) 26 is connected via a video I/F (not shown).

In the MPU 12, a user interface generator 12a is assembled as firmware, and further, a data memory (data memory for OSD and other applications) 12b is arranged.

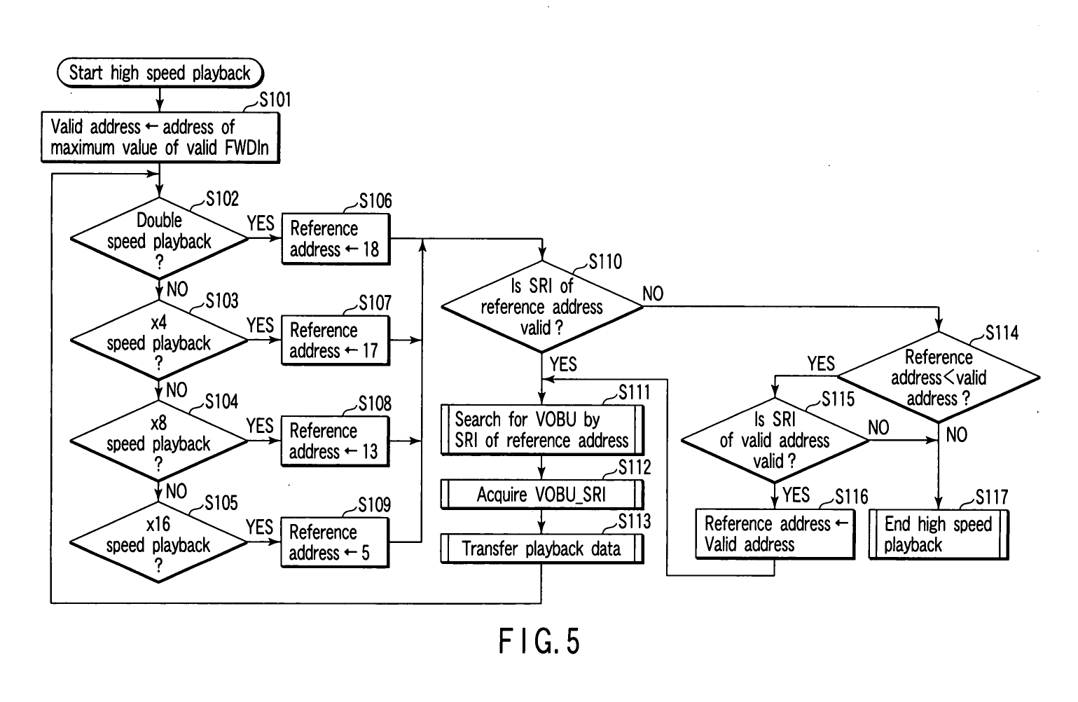

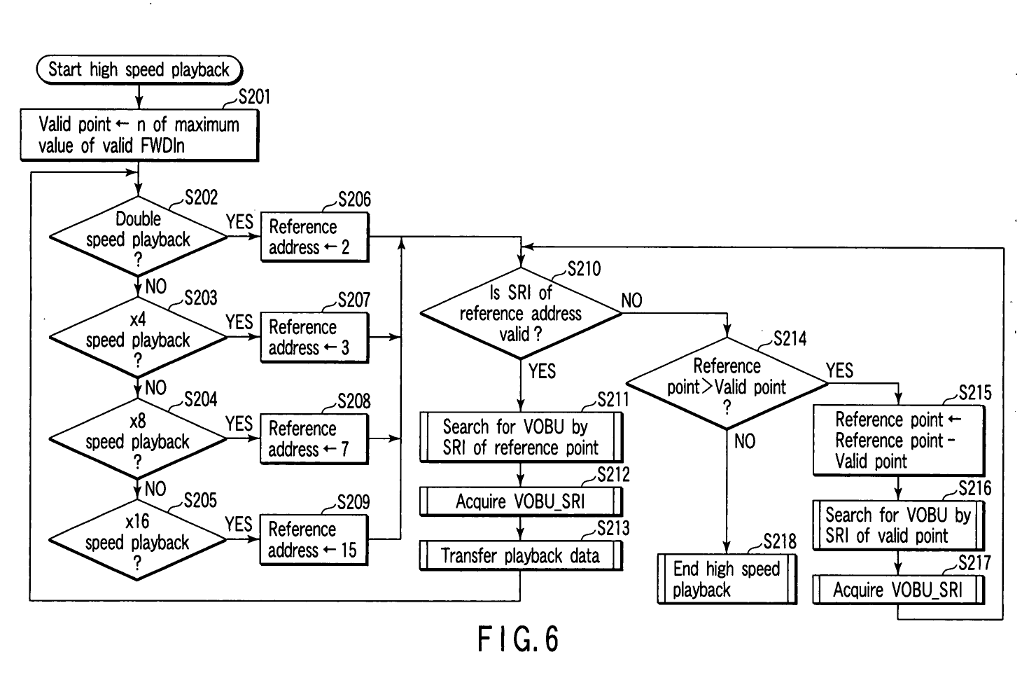

Although not illustrated in the figure, a program memory in which other firmware (a program for processes in FIGS. 5 and 6 to be described later) is written is also arranged in the MPU 12.

In system processor 16, a track buffer 16a, a data demultiplexor 16b and a memory I/F unit 16c are arranged.

The basic flow of data in the optical disc playback apparatus 11 shown in FIG. 1 is as follows. First, the MPU 12 sends a target address and a read command to the disc drive 15.

In accordance with the sent address and read command, the disc drive 15 reads target logic sector data from the optical disc 10, and sends the read pack data to the system processor 16 via a data input unit (not shown).

In the system processor 16, the data demultiplexor 16b separates the pack data sent via the track buffer 16a into packet data, and in accordance with data contents (objects), the system processor 16 transfers video packet data (MPEG encoded data) to the MPEG decoder 13, transfers audio packet data to the audio decoder 19, and transfers sub picture packet data to the SP decoder 18.

A navigation pack NV_PCK, and other packs (audio pack A_PCK, video pack V_PCK, sub picture pack SP_PCK and the like) are transferred to the work memory 17 via the memory I/F unit 16c and recorded therein in order for the MPU 12 to process them appropriately.

The respective items of packet data sent to the respective decoder units 13, 18, 19 are played back in synchronization with a value of a presentation time stamp PTS in the packet data. Thereby, it is possible to output, for example, a video image (movie) with English audio+Japanese subtitles on the screen of the TV monitor 26.

In the MPU 12, an on-screen display (OSD or the like) for providing a user interface for a user to perform visual operation and confirmation is generated by use of the internal data of the data memory 12b. This generation is performed by firmware called user interface generator 12a, and the generated OSD data is stored in the video memory 20.

In the MPU 12, a jump destination address determining unit 12c is provided in the form of firmware. The jump destination address determining unit 12c acquires a start address of VOBU to be played back next in order to perform fast-forward playback and fast-backward playback by means of search information SRI taken out from the navigation pack NV_PCK, and determines the target address and read command to the disc drive 15 on the basis of a set speed. A data structure of information to be recorded in one sheet of the optical disc 10 will be described later.

In the optical disc playback apparatus 11, set environments peculiar to each user generally including OSD language settings, screen shapes of a connected TV screen and the like are stored in the nonvolatile memory 24 in the playback apparatus 11.

When the system of the optical disc playback apparatus 11 is started, the playback apparatus 11 reads set environment information from the nonvolatile memory 24, and performs various kinds of settings on the basis of the information. In the present embodiment, the set information of a playback speed set by the user is stored in the nonvolatile memory 24.

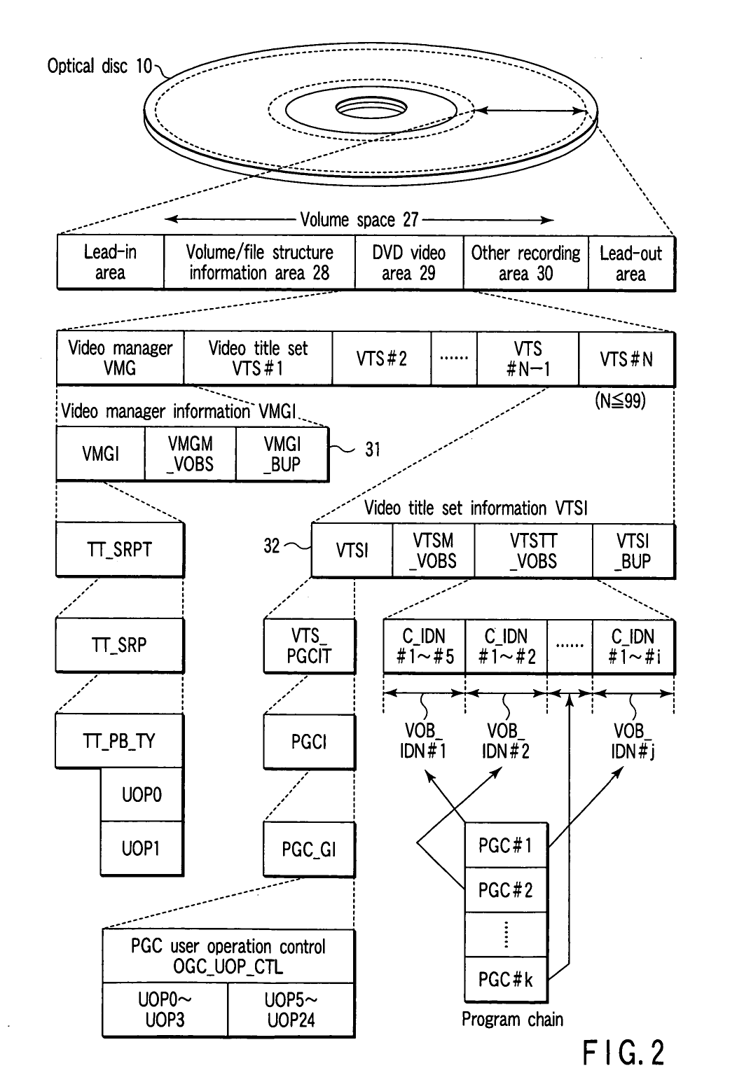

FIG. 2 shows a hierarchy structure of data in the above optical disc 10. In the optical disc 10, a lead-in area is provided at the inner circumferential side thereof, a lead-out area is provided at the external circumferential side thereof, and a volume space 27 is provided between the two areas.

The volume space 27 includes a volume/file structure information area 28, a DVD video area 29, other recording area 30 and the like. In the other recording area 30, information usable in a video title set VTS or other information not related with the video title set (for example, computer information) can be recorded. The recording area 30 is not mandatory, but may be deleted if not used.

The volume/file structure information area 28 corresponds to a management area specified in ISO 9660 and UDF bridge. On the basis of the description of this area 28, the contents of a video manager VMG are stored in the corresponding memory of the optical disc playback apparatus 11.

The areas 28 to 30 are divided on the borders of the logic sectors. Herein, one logic sector is defined as to be of 2048 bytes, and one logic block is also defined as to be of 2048 bytes. Therefore, one logic sector is defined equally to one logic block.

The DVD video area 29 includes management information called video manager VMG, and one or more items (99 items at maximum) of content information called video title set VTS#N.

The file 31 of the video manager VMG is structured by video manager information VMGI, video manager menu video object set VMGM_VOBS and video manager information VMGI backup VMGI_BUP.

The video manager information VMGI includes a video manager information management table VMGI_MAT (not shown), a title search pointer table TT_SRPT, a video manager menu PGCI unit table VMGM_PGCI_UT (not shown), a parental management information table PTL_MAIT (not shown), a video title set attribute table VTS_ATRT (not shown), a text data manager TXTDT_MG (not shown), a video manager menu cell address table VMGM_C_ADT (not shown), and a video manager menu video object unit address map VMGM_VOBU_ADMAP (not shown).

The title search pointer table TT_SRPT included in the video manager information VMGI includes title search pointer table information TT_SRPTI (not shown), and one or more title search pointers TT_SRP.

Each title search pointer TT_SRP includes a corresponding title playback format TT_PB_TY (showing one sequential PGC title, one random PGC title, a multi PGC title or the like), the number of angles AGL_Ns (not shown), the number of parts of title (number of chapters) PT_Ns (not shown), a corresponding title parental ID field TT_PTL_ID_FLD (not shown), a video title set number VTSN (not shown), a video title set title number VTS_TTN (not shown), and a video title set VTS start address VTS_SA.

Into the title playback format TT_PB_TY, a user operation flag bit UOP0 that determines whether or not to permit user operations of time search/time play, and a user operation flag bit UOP1 that determines whether or not to permit user operations of chapter search (PTT search)/chapter playback (PTT playback) may be described.

The file 32 of each video title set (shown as VTS#N in FIG. 2) is structured by video title set information VTSI as the management information of the title, a video title set menu video object set VTSM_VOBS (option), a video title set title video object set VTSTT_VOBS (video content) and a video title set information VTSI backup VTSI_BUP.

Any of the video objects VOBs in the respective video title sets VTSs has a similar structure except differences in their applications. To each video title set VTS, video data compressed according to MPEG standard, audio data compressed (or non compressed) according to a predetermined standard, and sub picture data which has been run-length compressed according to a predetermined standard, and further various items of information for playing back these items of data are stored. The number of the files 32 configuring the video title set VTS is determined to be, for example, 12 at maximum. The above files 31, 32 are divided by borders of logic sectors.

The management information VTSI of each video title set VTS includes a video title set information management table VTSI_MAT (not shown), a video title set part-of-title search pointer table VTS_PTT_SRPT (not shown), a video title set program chain information table VTS_PGCIT, a video title set menu PGCI unit table VTSM_PGCI_UT (not shown), a video title set time map table VTS_TMAPT (not shown), a video title set menu cell address table VTSM_C_ADT (not shown), a video title set menu video object unit address map VTSM_VOBU_ADMAP (not shown), a video title set cell address table VTS_C_ADT (not shown), and a video title set video object unit address map VTS_VOBU_ADMAP (not shown).

The video title set program chain information table VTS_PGCIT includes a video title set program chain information table information VTS_PGCITI (not shown), one or more video title set program chain information search pointers VTS_PGCI_SRP (not shown), and one or more items of video title set program chain information VTS_PGCI.

Each item of the video title set program chain information VTS_PGCI (hereinafter, program chain information PGCI) includes program chain general information PGC_GI, a program chain command table PGC_CMDT (not shown), a program chain program map PGC_PGMAP (not shown), a cell playback information table C_PBIT (not shown), and a cell position information table C_POSIT (not shown).

The program chain general information PGC_GI includes a program chain PGC content PGC_CNT (not shown), a program chain playback time PGC_PB_TM (not shown), a program chain user operation control PGC_UOP_CTL, a program chain audio stream control table PGC_AST_CTLT (not shown), a program chain sub picture stream control table PGC_SPST_CTLT (not shown), a program chain navigation control PGC_NV_CTL (not shown), a program chain sub picture pallet PGC_SP_PLT (not shown), a program chain command table PGC_CMDT start address PGC_CMDT_SA (not shown), a program chain program map PGC_PGMAP start address PGC_PGMAP_SA (not shown), a cell playback information table C_PBIT start address C_PBIT_SA (not shown), and a cell position information table C_POSIT start address C_POSIT_SA (not shown).

Into the program chain user operation control PGC_UOP_CTL, user operation flag bits UOP0 to UOP3 and UOP5 to UOP24 that determine whether or not the user operations are available at the time of playback of the program chain PGC may be described.

The contents of the video object set

VTSTT_VOBS for the video title set title of each video title set VTS are specified by video objects (VOB_IDN#1, VOB_IDN#2, . . . , VOB_IDN#j) indicating one or more cells (C_IDN#1 to C_IDN #5, C_IDN#1 to C_IDN#2, C_IDN#1 to #i), and the playback sequence of cells shown by the video objects VOB_IDN# is determined by program chains PGC#1, PGC#2, . . . , PGC#k.

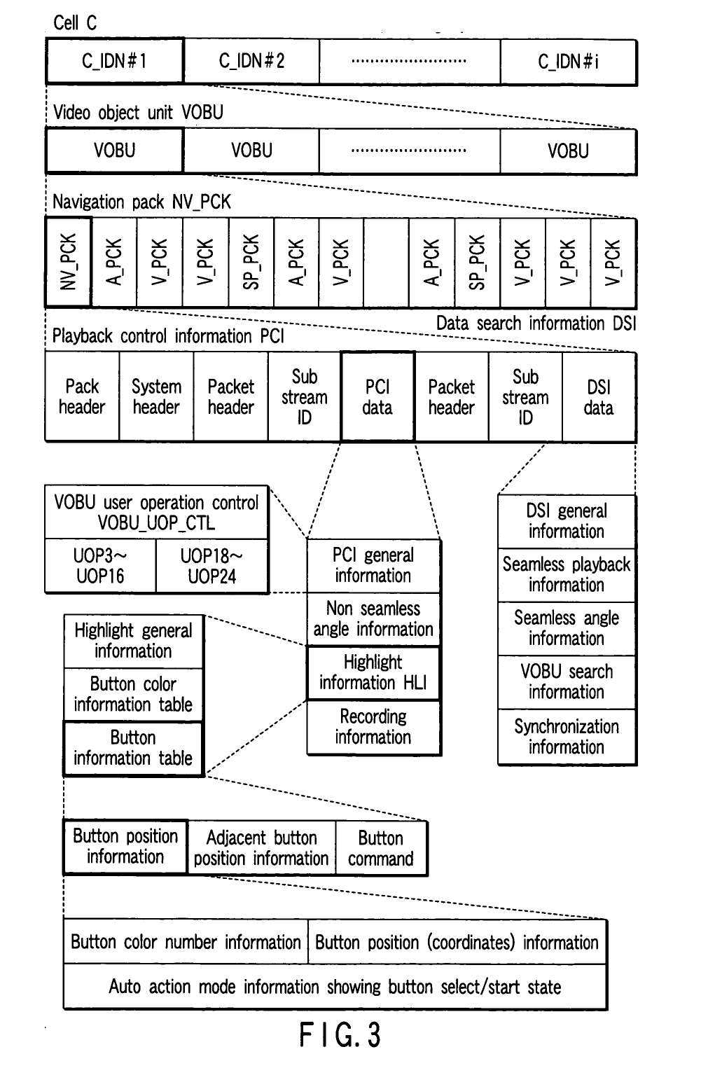

FIG. 3 shows a hierarchy data structure of the navigation pack NV_PCK to be recorded into the optical disc 10 shown in FIG. 2. By the video title set title video object set VTSTT_VOBS as a set of information in unit of cell, information of one or more program chains PGCs is recorded.

Namely, one video title set VTS is structured by one or more program chains PGCs, one program chain PGC is structured by one or more programs, one program is structured by one or more cells, and one cell is structured by a plurality of video object units VOBUs.

The data of each cell is separated into a plurality of video object units VOBUs and recorded. Each video object unit VOBU has a navigation pack NV_PCK at the head thereof, and is further structured by various kinds of data packs (an audio pack A_PCK, a video pack V_PCK, a sub picture pack SP_PCK and the like).

The pack is the minimum unit for performing a data transfer process. On the other hand, the minimum unit for performing a logical process is a cell. The logical processes (playback and the like) are performed in the unit of cell, and thereby it is possible to change playback sequences, and perform branching etc.

Each navigation pack NV_PCK is structured by a pack header, a system header, a packet header of a PCI packet, a sub stream ID of the PCI packet, playback control information (PCI data), a packet header of a DSI packet, a sub stream ID of the DSI packet, and data search information (DSI data).

The DSI data includes DSI general information, seamless playback information, seamless angle information, video object unit search information (VOBU_SRI) and synchronization information, etc.

The PCI data includes PCI general information, non seamless angle information, highlight information HLT, and recording information, etc.

The PCI general information includes a navigation pack address described by a relative logic block number NV_PCK_LBN (not shown), a corresponding video object unit VOBU category VOBU_CAT (not shown), a corresponding video object unit VOBU user operation control VOBU_UOP_CTL, a corresponding video object unit VOBU playback start time VOBU_E_PTS (not shown), a corresponding video object unit VOBU playback end time VOBU_E_PTS (not shown), an end time of an end sequence included in a corresponding video object unit VOBU VOBU_SE_E_PTS (not shown), a cell elapsed time C_ELTM and the like.

Into the video object unit VOBU user operation control VOBU_UOP_CTL, user operation flag bits UOP3 to UOP16 and UOP18 to UOP24 that determine whether or not user operations are available at the time of playback of a corresponding video object unit VOBU may be described.

In other words, according to the contents of the bit of the video object unit VOBU user operation control VOBU_UOP_CTL contained in the navigation pack NV_PCK, the kinds of keys available during playback of the video object unit VOBU are specified.

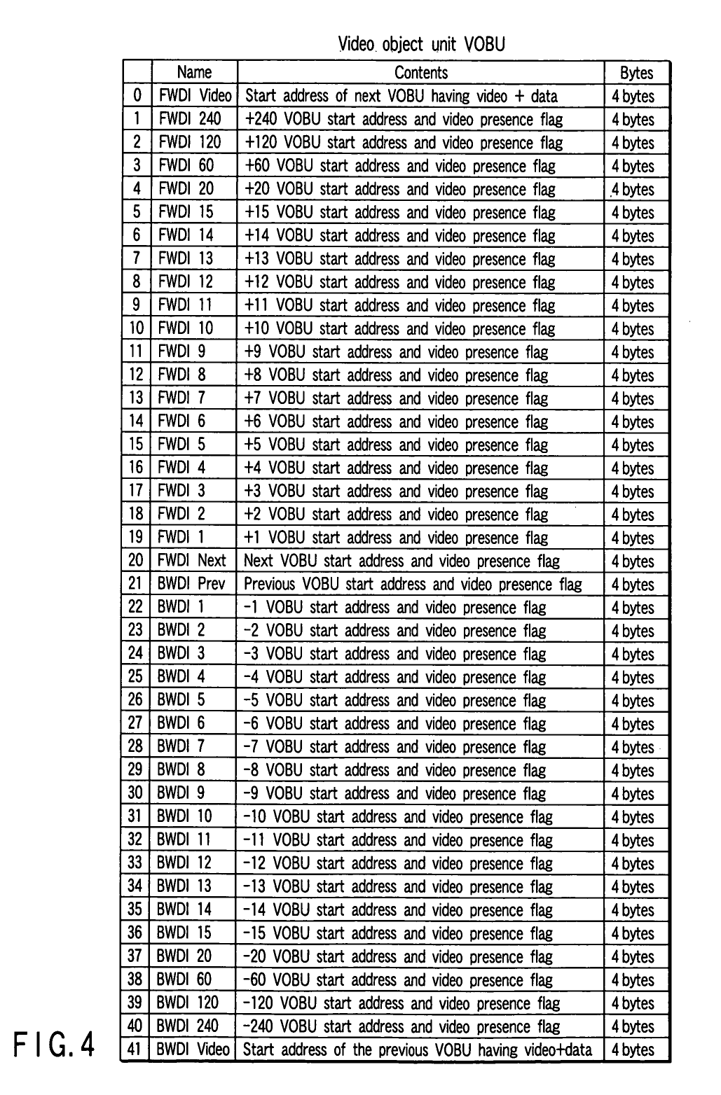

FIG. 4 shows a part of the navigation pack NV_PCK to be recorded into the optical disc 10 shown in FIG. 2. The information shown in FIG. 4 is the information included in the DSI data in the navigation pack NV_PCK shown in FIG. 3, and is the information VOBU_SRI (video object unit search information) having recorded therein a plurality of start addresses of VOBUs that are played back for 0.5×n seconds before and after the playback start time of the video object unit VOBU including this DSI in this cell. The VOBU_SRI is valid only in one cell. As described previously, valid data is not described in all the addresses of VOBU_SRI in some cases. Since the initial value of data of each address of the VOBU_SRI is 3FFF FFFFh, it is possible to know data is invalid or valid by determining whether or not the data is 3FFF FFFFh.

The SRI data of FWDIn (n=1, 2, . . . , 240) describe start addresses of VOBUs that are played back for 0.5×n seconds after the playback start time of the video object unit VOBU including this DSI, and flags showing whether or not there is video data in the addressed VOBU or in VOBUs from this VOBU to that VOBU. With regard to the start addresses, a start address of a corresponding VOBU is described by a relative logic block number (RBLN) from a head logic block (LB) of this VOBU. When a corresponding time exceeds the cell playback end time, 3FFF FFFFh is described.

The SRI data of FWDI Next describe a start address of a next VOBU, and a flag showing whether or not there is video data in the next VOBU. When the current VOBU is the last VOBU in this cell, the flag describes a value showing that there is no data. With regard to the start address, a start address of a corresponding VOBU is described by a relative logic block number (RBLN) from a head logic block (LB) of this VOBU. When the current VOBU is the last VOBU in this cell, 3FFF FFFFh is described.

The SRI data of FWDI Video describes a start address of a VOBU that accompanies a video stream first, among successive VOBUs. With regard to the start address, a start address of a corresponding VOBU is described by a relative logic block number (RBLN) from a head logic block (LB) of this VOBU. When a corresponding time exceeds the cell playback end time, 3FFF FFFFh is described.

The SRI data of BWDIn (n=1, 2, . . . , 240) describe start addresses of VOBUs that are played back for 0.5×n seconds before the playback start time of the video object unit VOBU including this DSI, and flags showing whether or not there is video data in the addressed VOBU or in VOBUs to this VOBU. With regard to the start addresses, a start address of a corresponding VOBU is described by a relative logic block number (RBLN) from a head logic block (LB) of this VOBU. When a corresponding time exceeds the cell playback start time, 3FFF FFFFh is described.

The SRI data of BWDI Prev describe a start address of the last previous VOBU, and a flag showing whether or not there is video data in the VOBU. When the current VOBU is the head VOBU in this cell, the flag describes a value showing that there is no data. With regard to the start address, a start address of a corresponding VOBU is described by a relative logic block number (RBLN) from a head logic block (LB) of this VOBU. When the current VOBU is the head VOBU in this cell, 3FFF FFFFh is described.

The SRI data of BWDI Video describes a start address of a VOBU that accompanies a video stream first, among foregoing VOBUs. With regard to the start address, a start address of a corresponding VOBU is described by a relative logic block number (RBLN) from a head logic block (LB) of this VOBU. When the current VOBU is the head VOBU in this cell, 3FFF FFFFh is described.

During playback of the optical disc 10, the user performs a key operation to execute fast-forward playback or fast-backward playback, or, executes the user interface equivalent to the key operation. In this case, a jump address of the video object unit VOBU corresponding to the set speed is acquired from the video object unit search information VOBU_SRI in the above DSI, and the address is issued to the disc drive 15 as a target address together with a read command, whereby data to be played back is input to the respective decoder units 13, 18, 19, so that fast-forward playback or fast-backward playback becomes available.

FIG. 5 is a flow chart for explaining a high speed playback operation in the optical disc playback apparatus in FIG. 1. There are slight differences between a high speed playback in the normal direction and that in the reverse direction, and FIG. 5 shows an example of a high speed playback in the normal direction.

When a high speed playback in the normal direction is designated in normal playback, it is determined in step S101 whether the contents of FWDIn recorded in each address of the VOBU_SRI of the VOBU now under playback are invalid (3FFF FFFFh) or valid. Based on the determination, an address recording the maximum value of FWDIn of valid contents is made a valid address. For example, assuming that valid start addresses are recorded up to FWDI 13, and invalid data 3FFF FFFFh are recorded in FWDI 14, FWDI 15, FWDI 20, FWDI 60, FWDI 120, and FWDI 240, “7” as the record address of FWDI 13 is made a valid address.

In steps S102, S103, S104, and S105, it is determined what a speed magnification the playback speed is (herein, one of double speed, ×4 speed, ×8 speed, and ×16 speed). If the user operates the fast-forward key during normal playback, the playback speed of the contents is changed into double speed. If, with the double speed playback executed, the user operates the fast-forward key again, the playback speed of the contents is changed into 4-time speed. If the user further operates the fast-forward key in this state, the playback speed of the contents is changed into 8-time speed. Further, if the user operates the fast-forward key once again, the playback speed of the contents is changed into 16-time speed. Then, if, in the state of this 16-time speed playback, the user operates the fast-forward key again, the playback speed of the contents is changed into double speed. Thereafter, in the same manner as the above, the playback speed is changed cyclically every time when the user operates the fast-forward key. In this playback apparatus, +2VOBU (second next VOBU in time sequence) is played back next in the case of double speed, +3VOBU is played back next in the case of 4-time speed, +7VOBU is played back next in the case of 8-time speed, and +15VOBU is played back next in the case of 16-time speed. Therefore, in the case of double speed, the record address “18” of FWD 2 having the +2VOBU start address recorded therein is made a reference address in step S106. In the case of 4-time speed, the record address “17” of FWD 3 is made a reference address in step S107. In the case of 8-time speed, the record address “13” of FWD 7 is made a reference address in step S108. In the case of 16-time speed, the record address “5” of FWD 15 is made a reference address in step S109.

In step S110, it is determined whether or not the data of the VOBU_SRI of the reference address is valid. Namely, in the case of 16-time speed, it is determined whether or not the +15VOBU start address recorded in FWDI 15 of the record address “5” is 3FFF FFFFh. Herein, it is determined the start address is invalid.

When the data of the VOBU_SRI of the reference address is valid (high speed playback up to 8-time speed), in step S111, a VOBU to be played back next is searched for by the data of the VOBU_SRI of the reference address (VOBU start address), and in step S112, VOBU_SRI of the VOBU to be played back next is acquired. For example, in the case of 8-time speed, the seventh next VOBU in time sequence is searched for from the contents (+7VOBU) in FWDI 7 of the record address “13”. In step S113, data of the corresponding VOBU is transferred, and the procedure goes back to step S102 again.

When the data of the VOBU_SRI of the reference address is invalid (high speed playback at 16-time speed), it is determined in step S114 whether or not the reference address is the valid address or less. In the case where the data of the VOBU_SRI of the reference address is invalid, the reference address is normally the valid address or less. The case where the reference address is not the valid address or less means the case with some error. In this case, the high speed playback is ended in step S117.

When the reference address is the valid address or less in the determination in step S114, it is determined in step S115 whether or not the data of the VOBU_SRI of the valid address (herein “7”) is valid. The case where the SRI data of the valid address is invalid means the case where the playback near the end of its range, and the jump destination is out of the playback range. In this case, the high speed playback is ended in step S117.

When the data of the VOBU_SRI of the valid address is valid in the determination in step S115, the value “7” of the valid address is substituted as the value of the reference address (“7” instead of “5”) in step S116. Then, the procedure goes back to step S111, wherein +13VOBU is searched for by the data of FWDI 13 recorded in the updated reference address “7”, and a high speed playback is performed.

Meanwhile, in the case of a high speed playback in the reverse direction, step S101 is changed into that “the address recording the maximum value of BWDIn of valid contents is made a valid address”, and the determination in step S114 is changed into “whether or not the reference address is over the valid address”. Others are same, and therefore, explanation thereof is omitted herein.

According to the first embodiment, there is provided an information playback method in which information is recorded for each data unit, a playback speed of the information is variable, and a table storing addresses of data units to be played back in a time range including current time is prepared for each data unit, the information playback method comprising:

reading a table of one of the data units and playing back the one of the data units;

receiving an instruction for a high speed playback and obtaining a number of data units to be played back by jumping in accordance with the playback speed;

determining whether an address corresponding to the obtained number in the table is valid or invalid;

reading a table of a data unit of an address corresponding to the obtained number and playing back the data unit when it is determined that the address is valid; and

reading a table of a data unit of an address corresponding to a data unit to be played back at a time point closer to the current time point than a playback time point of a data unit of the invalid address and playing back the data unit when it is determined that the address is invalid.

As explained above, according to the first embodiment, even if data of FWDIn corresponding to the speed magnification of high speed playback is invalid, jump playback is performed on the basis of the data of valid FWDIn corresponding to a speed magnification that is highest among lower ones than it. Thereby, it is possible to perform a high speed playback correctly, without ending the playback halfway.

Note that there is a case where a high speed playback at a desired magnification cannot be attained simply by replacing a valid FWDIn with an FWDIn closest thereto in time sequence. However, as described above, the speed magnification of high speed playback corresponds to what n-th previous/next VOBU should be played back, and the playback time of one VOBU. Therefore, the playback time of one VOBU may be shortened for the number of jumps decreased from the desired number, and a high speed playback at a desired magnification may be realized.

Other embodiments of the apparatus and method according to the present invention will be described. The same portions as those of the first embodiment will be indicated in the same reference numerals and their detailed description will be omitted. FIG. 6 is a flow chart for explaining a process operation of a high speed playback in the second embodiment. There are slight differences between a high speed playback in the normal direction and that in the reverse direction, and FIG. 6 shows an example of a high speed playback in the normal direction.

When a high speed playback in the normal direction is designated in normal playback, it is determined in step S201 whether the contents of FWDIn recorded in each address of the VOBU_SRI of the VOBU that is now under playback are invalid (3FFF FFFFh) or valid. The “n” as a parameter of the maximum value of FWDIn of valid contents is made a valid point. In the same manner as in FIG. 5, when valid start addresses are recorded in FWDIs up to FWDI 13, and invalid data 3FFF FFFFh are recorded in FWDIs on and after FWDI 14, “13” as a parameter of FWDI 13 is made a valid point.

In steps S202, S203, S204, and S205, it is determined what a speed magnification the playback speed is (herein, one of double speed, 4-time speed, 8-time speed, and 16-time speed). In the same manner as in FIG. 5, +2VOBU is played back next in the case of double speed, +3VOBU is played back next in the case of 4-time speed, +7VOBU is played back next in the case of 8-time speed, and +15VOBU is played back next in the case of 16-time speed. Therefore, in the case of double speed, the parameter “2” of FWD 2 having the +2VOBU start address recorded therein is made a reference point in step S206. In the case of 4-time speed, the parameter “3” of FWD 3 is made a reference point in step S207. In the case of 8-time speed, the parameter “7” of FWD 7 is made a reference point in step S208. In the case of 16-time speed, the parameter “15” of FWD 15 is made a reference point in step S209.

In step S210, it is determined whether or not the data of FWDIn having the reference point of VOBU_SRI as the parameter thereof is valid. More specifically, in the case of 16-time speed, it is determined whether or not the +15VOBU start address of FWDI 15 is 3FFF FFFFh. Herein, it is determined the start address is invalid.

When the data of FWDIn having the reference point as the parameter thereof is valid (high speed playback up to 8-time speed), in step S211, a VOBU to be played back next is searched for by the data of FWDIn having the reference point as the parameter thereof (VOBU start address), and in step S212, VOBU_SRI of the VOBU is acquired. For example, in the case of 8-time speed, the reference point is “7”, and therefore, +7VOBU is searched for from the contents of FWDI 7. In step S213, playback data of the corresponding VOBU is transferred, and the procedure goes back to step S202 again.

When the data of FWDI 15 having the reference point “15” as the parameter thereof is invalid (high speed playback at 16-time speed) in the determination in step S210, it is determined in step S214 whether or not the reference point is the valid point or more. The case where the reference point is not the valid point or more means the case where the playback is near the end of its range, and the jump destination is out of the playback range. In this case, the high speed playback is ended in step S218.

When the reference point “15” is the valid point “13” or more, the point obtained by subtracting the valid point “13” from the reference point “15” is made a new reference point. In this case, “2” becomes the new reference point. Thereafter, in step S216, +13VOBU is searched for by the data of FWDI 13 having the valid point “13” as the parameter thereof, and in step S217, VOBU_SRI of that VOBU is acquired. Thereafter, the procedure goes back to step S210. At this moment, the reference point is “2”, the data is determined as valid in the determination in step S210, and step S211 and subsequent steps are performed.

Specifically, when the reference point is larger than the valid point, the data of the reference point to be referred to in high speed playback is invalid. Therefore, not only the parameter of the reference point is acquired by jumping data at one time, but also every parameter of the valid point is acquired by jumping VOBU_SRI several times, and playback data is acquired finally, thereby a high speed playback at a desired speed can be performed.

Meanwhile, in the case of a high speed playback in the reverse direction, step S201 is changed into that “the address recording the maximum value of BWDIn of valid contents is made a valid address”. Others are same, and therefore, explanation thereof is omitted herein.

According to the second embodiment, there is provided an information playback method in which information is recorded for each data unit, a playback speed of the information is variable, and a table storing addresses of data units to be played back in a time range including current time is prepared for each data unit, the information playback method comprising:

reading a table of one of the data units and playing back the one of the data units;

receiving an instruction for a high speed playback and obtaining a number of data units to be played back by jumping in accordance with the playback speed;

determining whether an address corresponding to the obtained number in the table is valid or invalid;

acquiring a table from a data unit designated by an address stored in a data unit to be played back at a second time point closest to the playback time point of the data unit of the invalid address among valid addresses, decreasing the number of data units to be played back by jumping in accordance with the data unit to be played back at the second time point, and causing the determining operate again when it is determined that the address is invalid; and

reading a table of a data unit of an address corresponding to a valid address and playing back the data unit when it is determined that the address is valid.

As explained above, according to the second embodiment, even if data of FWDIn corresponding to the speed magnification of high speed playback is invalid, it is possible to perform a high speed playback correctly by use of the data of valid FWDIn having the largest n among FWDIn whose n is smaller than it (closest in time sequence), without ending the playback halfway. For example, in the case where recording is made up to FWDI 13, but the start address of +15VOBU is required, the start address of +13VOBU is found from FWDI 13, and the start address of +2VOBU is found from FWDI 2 of that VOBU_SRI, so that playback data is acquired.

As explained above, according to the embodiments, even if an address of data to be played back next is not recorded in a disc, playback is performed on the basis of the valid address among addresses of data units to be played back at the time point that is closer to the current time point than the playback time point of the data to be played back next. Therefore, it is possible to provide an information playback apparatus and an information playback method that realize a high speed playback.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. Some structural elements may be deleted from all the elements shown in the embodiments. Furthermore, such structural elements may be appropriately combined with a different embodiment. The present invention can be practiced as a computer readable recording medium in which a program for allowing the computer to function as predetermined means, allowing the computer to realize a predetermined function, or allowing the computer to conduct predetermined means.

What is claimed is:

1. An information playback apparatus in which information is recorded for each data unit, a playback speed of the information is variable, and a table storing addresses of data units to be played back in a time range including current time is prepared for each data unit, the information playback apparatus comprising:
a unit configured to obtain a number of data units to be played back by jumping in accordance with the playback speed;
a determination unit configured to determine whether an address in the table corresponding to the obtained number is valid or invalid; and
a playback unit configured to, when it is determined that the address is valid, play back information based on the valid address, and when it is determined that the address is invalid, play back information based on a valid address among addresses of data units to be played back at a time point closer to the current time point than a playback time point of a data unit of the invalid address.

2. An information playback apparatus according to claim 1, wherein, when it is determined that the address is valid, the playback unit plays back a data unit of the valid address, and when it is determined that the address is invalid, the playback unit plays back a data unit of the address of the data unit to be played back at a time point closest to the playback time point of the data unit of the invalid address among valid addresses.

3. An information playback apparatus according to claim 1, wherein, when it is determined that the address is valid, the playback unit plays back a data unit of the valid address, and, when it is determined that the address is invalid, the playback unit acquires a table from a data unit designated by an address stored in a data unit to be played back at a second time point closest to the playback time point of the data unit of the invalid address among valid addresses, decreases the number of data units to be played back by jumping in accordance with the data unit to be played back at the second time point, and causes the determination unit operate again.

4. An information playback method in which information is recorded for each data unit, a playback speed of the information is variable, and a table storing addresses of data units to be played back in a time range including current time is prepared for each data unit, the information playback method comprising:
obtaining a number of data units to be played back by jumping in accordance with the playback speed;
determining whether an address in the table corresponding to the obtained number is valid or invalid; and
playing back, when it is determined that the address is valid, information based on the valid address, and when it is determined that the address is invalid, information based on a valid address among addresses of data units to be played back at a time point closer to the current time point than a playback time point of a data unit of the invalid address.

5. An information playback method according to claim 4, wherein, when it is determined that the address is valid, a data unit of the valid address is played back, and when it is determined that the address is invalid, a data unit of the address of the data unit to be played back at a time point closest to the playback time point of the data unit of the invalid address among valid addresses is played back.

6. An information playback method according to claim 4, wherein, when it is determined that the address is valid, a data unit of the valid address is played back, and, when it is determined that the address is invalid, a data unit to be played back at a second time point closest to the playback time point of the data unit of the invalid address among valid addresses is acquired from the table, the number of data units to be played back by jumping is decreased in accordance with the data unit to be played back at the second time point, and the determination step is caused to be operated again.

7. An information playback method in which information is recorded for each data unit, a playback speed of the information is variable, and a table storing addresses of data units to be played back in a time range including current time is prepared for each data unit, the information playback method comprising:
reading a table of one of the data units and playing back the one of the data units;
receiving an instruction for a high speed playback and obtaining a number of data units to be played back by jumping in accordance with the playback speed;
determining whether an address corresponding to the obtained number in the table is valid or invalid;
reading a table of a data unit of an address corresponding to the obtained number and playing back the data unit when it is determined that the address is valid; and
reading a table of a data unit of an address corresponding to a data unit to be played back at a time point closer to the current time point than a playback time point of a data unit of the invalid address and playing back the data unit when it is determined that the address is invalid.
